(19) United States
(12) Patent Application Publication
(10) Pub. No.: US 2026/0141885 A1
(43) Pub. Date: May 21, 2026

(54) ELECTRONIC DEVICE AND METHOD FOR AUDIO PROCESSING

(71) Applicant: Merry Electronics(Shenzhen) Co., Ltd., ShenZhen (CN)

(72) Inventors: Chiang-Kai Wu, Taichung (TW); Guan-De Kuo, Taichung (TW)

(73) Assignee: Merry Electronics(Shenzhen) Co., Ltd., ShenZhen (CN)

(21) Appl. No.: 18/985,032

(22) Filed: Dec. 18, 2024

(30) Foreign Application Priority Data
Nov. 19, 2024 (TW) 113144360

(51) Int. Cl. G10K 11/178; H04R 1/10

(52) U.S. Cl. CPC G10K 11/1783; G10K 11/17823; G10K 11/17825; G10K 11/17881; H04R 1/1083; G10K 2210/3012; H04R 2460/01; H04R 2460/03

(57) ABSTRACT

An electronic device and a method for audio processing are provided. The method includes the following steps. A sound signal is detected through a feedback microphone. One of a first configuration and a second configuration of a sound parameter is selected to obtain a selected configuration. An audio is output through a speaker according to the selected configuration.

### CROSS-REFERENCE TO RELATED APPLICATION

This application claims the priority benefit of Taiwan application serial no. 113144360, filed on Nov. 19, 2024. The entirety of the above-mentioned patent application is hereby incorporated by reference herein and made a part of this specification.

### BACKGROUND

### Technical Field

The disclosure relates to a signal processing technology, and in particular to an electronic device and a method for an audio processing.

### Description of Related Art

Currently, mainstream true wireless stereo (TWS) earphones available on the market may include in-ear earphones, open earphones, or semi-open earphones. In-ear earphones have the advantage of low sound leakage, effectively isolating environmental noise. However, in-ear earphones may cause pressure on the user's ear canal, increasing the discomfort of wearing the earphones and raising the risk of ear canal infections for users. Open or semi-open earphones do not cause pressure on the user's ear canal, making them more suitable for scenarios requiring long-duration use of earphones. However, open or semi-open earphones have poor sound isolation, making them unsuitable for use in noisy environments, and the sound output by open or semi-open earphones may easily leak and disturb others. If users wish to enjoy the advantages of both in-ear earphones and open or semi-open earphones, they typically need to purchase multiple pairs of earphones.

### SUMMARY

The disclosure provides an electronic device and a method for an audio processing, which may configure a sound parameter for an earphone capable of switching between an in-ear mode and an open-ear mode.

An electronic device for an audio processing includes a feedback microphone, a speaker, and a processor. The feedback microphone detects a sound signal. The processor is coupled to the feedback microphone and the speaker. The processor selects one of a first configuration and a second configuration of a sound parameter according to the sound signal to obtain a selected configuration. The processor outputs an audio through the speaker according to the selected configuration.

In an embodiment of the disclosure, the electronic device further includes a skin sensor. The skin sensor is coupled to the processor and generates a detection result. The processor activates the feedback microphone to detect the sound signal according to the detection result.

In an embodiment of the disclosure, the processor obtains a feature value corresponding to the sound signal and determines whether the feature value is greater than a threshold value. In response to the feature value being greater than the threshold value, the processor selects the first configuration as the selected configuration.

In an embodiment of the disclosure, in response to the feature value being less than or equal to the threshold value, the processor selects the second configuration as the selected configuration.

In an embodiment of the disclosure, the feature value includes a root mean square volume.

In an embodiment of the disclosure, the electronic device further includes a filter. The filter is coupled to the processor. The processor processes the sound signal using the filter to generate a filtered signal and obtains a feature value of the filtered signal.

In an embodiment of the disclosure, the electronic device further includes an environmental microphone. The environmental microphone is coupled to the processor and detects an environmental sound signal. The processor determines the threshold value according to the environmental sound signal.

In an embodiment of the disclosure, the electronic device further includes a transceiver. The transceiver is coupled to the processor. The processor is communicatively connected to an external electronic device through the transceiver and receives a calibration command from the external electronic device. In response to the calibration command, the processor detects a first sound signal and a second sound signal different from the first sound signal through the feedback microphone. The processor determines the threshold value according to the first sound signal and the second sound signal.

In an embodiment of the disclosure, the sound parameter includes at least one of an equalizer parameter, an active noise cancellation parameter, and a compensation parameter.

In an embodiment of the disclosure, the electronic device includes an earphone.

The disclosure further provides a method for an audio processing including the following steps. A sound signal is detected through a feedback microphone. One of a first configuration and a second configuration of a sound parameter is selected according to the sound signal to obtain a selected configuration. An audio is output through a speaker according to the selected configuration.

In an embodiment of the disclosure, the method further includes the following steps. A detection result is generated through a skin sensor. The feedback microphone is activated to detect the sound signal according to the detection result.

In an embodiment of the disclosure, the step of selecting the one of the first configuration and the second configuration of the sound parameter according to the sound signal to obtain the selected configuration includes the following steps. A feature value corresponding to the sound signal is obtained. Whether the feature value is greater than a threshold value is determined. In response to the feature value being greater than the threshold value, the first configuration is selected as the selected configuration.

In an embodiment of the disclosure, the step of selecting the one of the first configuration and the second configuration of the sound parameter according to the sound signal to obtain the selected configuration further includes the following step. In response to the feature value being less than or equal to the threshold value, the second configuration is selected as the selected configuration.

In an embodiment of the disclosure, the feature value includes a root mean square volume.

In an embodiment of the disclosure, the step of obtaining the feature value corresponding to the sound signal includes the following steps. The sound signal is processed using a filter to generate a filtered signal. A feature value of the filtered signal is obtained.

In an embodiment of the disclosure, the method further includes the following steps. An environmental sound signal is detected through an environmental microphone. The threshold value is determined according to the environmental sound signal.

In an embodiment of the disclosure, the method further includes the following steps. A calibration command is received from an external electronic device. In response to the calibration command, a first sound signal and a second sound signal different from the first sound signal is detected through the feedback microphone. The threshold value is determined according to the first sound signal and the second sound signal.

In an embodiment of the disclosure, the sound parameter includes at least one of an equalizer parameter, an active noise cancellation parameter, and a compensation parameter.

Based on the above, the electronic device of the disclosure may configure optimal sound parameters for an earphone according to the earphone mode, such that the audio output by the earphone matches the earphone mode.

### BRIEF DESCRIPTION OF THE DRAWINGS

FIG. 1 illustrates a schematic diagram of an electronic device for audio processing according to an embodiment of the disclosure.

FIG. 2 illustrates a flowchart of an audio processing method according to an embodiment of the disclosure.

FIG. 3 illustrates a flowchart of a method for audio processing according to an embodiment of the disclosure.

### DESCRIPTION OF THE EMBODIMENTS

To facilitate understanding of the disclosure, the following embodiments are provided as examples demonstrating how the disclosure may indeed be implemented. Additionally, where possible, the same reference numerals are used in the drawings and embodiments to denote the same or similar elements/components/steps.

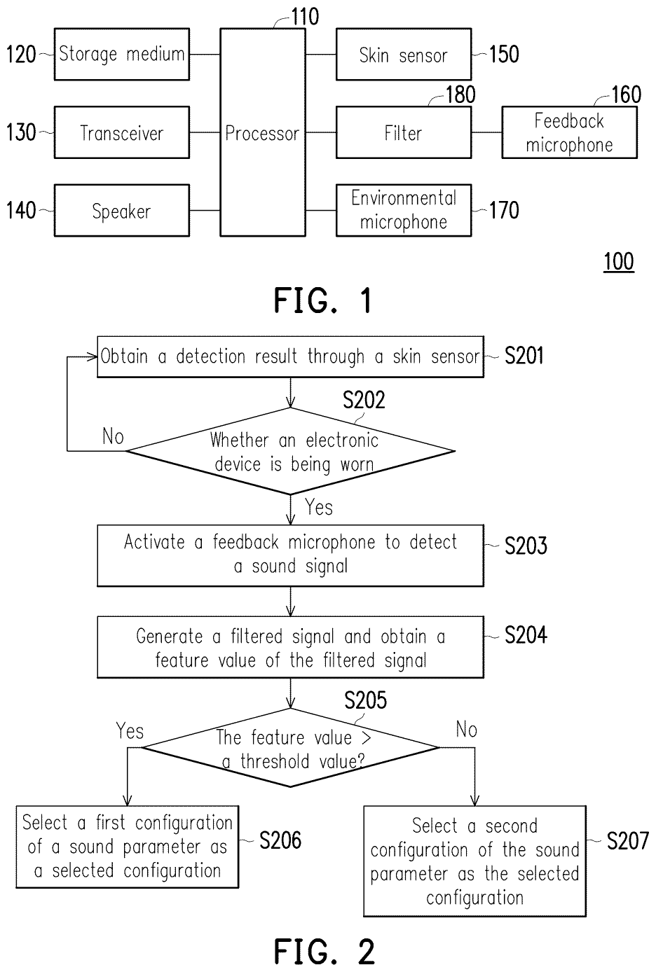

FIG. 1 illustrates a schematic diagram of an electronic device 100 for audio processing according to an embodiment of the disclosure. The electronic device 100, for example, is an earphone. In an embodiment, the earphone may be configured to switch between an in-ear earphone mode and an open or semi-open earphone mode. For example, the earphone may include a mechanism for securing an earbud. When the earbud is disposed on the earphone, the earphone may operate in the in-ear earphone mode. When the earbud is not disposed on the earphone, the earphone may operate in the open earphone mode. The electronic device 100 may include a processor 110, a storage medium 120, a transceiver 130, a speaker 140, a skin sensor 150, a feedback microphone 160, an environmental microphone 170, and a filter 180.

The processor 110, for example, may be a central processing unit (CPU) or other programmable general-purpose or special-purpose microcontroller unit (MCU), microprocessor, digital signal processor (DSP), programmable controller, application-specific integrated circuit (ASIC), graphics processing unit (GPU), image signal processor (ISP), image processing unit (IPU), arithmetic logic unit (ALU), complex programmable logic device (CPLD), field-programmable gate array (FPGA), or other similar components or combinations of the aforementioned components. The processor 110 may be coupled to the storage medium 120, the transceiver 130, the speaker 140, the skin sensor 150, the feedback microphone 160, the environmental microphone 170, or the filter 180. The processor 110 may access and execute multiple modules and various applications stored in the storage medium 120.

The storage medium 120, for example, may be any type of fixed or removable random access memory (RAM), read-only memory (ROM), flash memory, hard disk drive (HDD), solid state drive (SSD), or similar components, or combinations of the aforementioned components. It is used to store multiple modules or various applications executable by the processor 110. In an embodiment, the storage medium 120 may store multiple configurations of sound parameters.

The transceiver 130 transmits or receives signals in a wireless or wired manner. The transceiver 130 may also perform operations such as low-noise amplification, impedance matching, mixing, up or down frequency conversion, filtering, amplification, and similar processes. The processor 110 may communicate with external electronic devices through the transceiver 130.

The speaker 140 may include a dynamic speaker, an electrostatic speaker, a planar magnetic speaker, or a piezoelectric speaker.

The skin sensor 150 may be disposed on the surface of the earphone and may generate a detection result. The skin sensor 150 may be configured to contact the user's skin when the electronic device 100 is worn by the user. The detection result of the skin sensor 150 may indicate whether the user's skin is in contact with the skin sensor 150. If the detection result indicates that the user's skin is in contact with the skin sensor 150, the processor 110 may determine, according to the detection result, that the electronic device 100 is being worn by the user. If the detection result indicates that the user's skin is not in contact with the skin sensor 150, the processor 110 may determine, according to the detection result, that the electronic device 100 is not being worn by the user.

The feedback microphone 160 or the environmental microphone 170 may include a dynamic microphone, a condenser microphone, an electret condenser microphone, a micro-electrical mechanical system (MEMS) microphone, a ribbon microphone, or a carbon microphone. When the user wears the earphone (e.g., the electronic device 100), the feedback microphone 160 may be used to detect sound signals near the user's ear canal. The environmental microphone 170 may be used to detect environmental sound signals in the surrounding environment. The feedback microphone 160 and the environmental microphone 170 may be the same or different microphones.

The filter 180 may be configured in the filter circuit between the processor 110 and the feedback microphone 160. The processor 110 may use the filter 180 to process the sound signal detected by the feedback microphone 160 to generate a filtered signal. The filter 180, for example, may be a high-pass filter used to filter out sound signals with frequencies below 1000 Hz.

FIG. 2 illustrates a flowchart of an audio processing method according to an embodiment of the disclosure, where the audio processing method may be implemented by the electronic device 100 as shown in FIG. 1.

In step S201, the processor 110 may obtain a detection result through the skin sensor 150.

In step S202, the processor 110 may determine whether the electronic device 100 is being worn by the user according to the detection result. If the detection result indicates that the user's skin is in contact with the skin sensor 150, the processor 110 may determine that the electronic device 100 is being worn by the user and proceed to step S203. If the detection result indicates that the user's skin is not in contact with the skin sensor 150, the processor 110 may determine that the electronic device 100 is not being worn by the user and re-execute step S201.

In step S203, the processor 110 may activate the feedback microphone 160 to detect a sound signal according to the detection result. Specifically, when the electronic device 100 is not being worn by the user, the processor 110 may disable the feedback microphone 160 to save power. After the processor 110 determines that the electronic device 100 is being worn by the user, the processor 110 may activate the feedback microphone 160 to detect a sound signal.

In step S204, the processor 110 may use the filter 180 to process the sound signal to generate a filtered signal and obtain a feature value of the filtered signal. In an embodiment, the feature value may include a root mean square volume, as shown in Equation (1), where F is the root mean square volume, n is the total number of samples of the filtered signal, and xi is the value of the i-th sample among the n samples.

$$F = \sqrt{( \frac{1}{n} ) \cdot \sum ( {xi}^{2} )} \qquad ( 1 )$$

In step S205, the processor 110 may determine whether the feature value is greater than the threshold value. If the feature value is greater than the threshold value, it indicates that the electronic device 100 is likely operating in the in-ear earphone mode. Accordingly, the processor 110 may proceed to step S206. If the feature value is less than or equal to the threshold value, it indicates that the electronic device 100 is likely operating in the open earphone mode. Accordingly, the processor 110 may proceed to step S207.

In an embodiment, the processor 110 may detect an environmental sound signal through the environmental microphone 170 and determine the threshold value according to the environmental sound signal. For example, if the value of the environmental sound signal exceeds a preset value, the processor 110 may determine that the electronic device 100 is in a noisy environment. Accordingly, the processor 110 may increase the threshold value to avoid being influenced by noise and incorrectly determining that the electronic device 100 has switched from the open earphone mode to the in-ear earphone mode. On the other hand, if the value of the environmental sound signal does not exceed the preset value, the processor 110 may determine that the electronic device 100 is in a quiet environment. Accordingly, the processor 110 may decrease the threshold value.

In an embodiment, a user may operate an external electronic device (e.g., a smartphone) to determine the threshold value. Specifically, the user may operate the external electronic device to send a calibration command to the processor 110, where the calibration command may indicate that the user is wearing the electronic device 100 in the in-ear earphone mode or the open earphone mode. While the user is wearing the electronic device 100 in the in-ear earphone mode, the processor 110 may detect a first sound signal through the feedback microphone 160. On the other hand, while the user is wearing the electronic device 100 in the open earphone mode, the processor 110 may detect a second sound signal through the feedback microphone 160. The processor 110 may determine the threshold value according to the first sound signal and the second sound signal.

In step S206, the processor 110 may select a first configuration of the sound parameters corresponding to the in-ear earphone mode as the selected configuration. The processor 110 may output audio through the speaker 140 according to the selected configuration. The sound parameters may include equalizer parameters, active noise cancellation (ANC) parameters, or compensation parameters.

In step S207, the processor 110 may select a second configuration of the sound parameters corresponding to the open earphone mode as the selected configuration. The processor 110 may output audio through the speaker 140 according to the selected configuration.

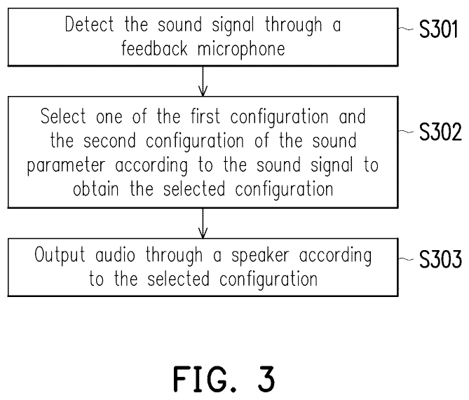

FIG. 3 illustrates a flowchart of a method for audio processing according to an embodiment of the disclosure, where the method may be implemented by the electronic device 100 as shown in FIG. 1. In step S301, a sound signal is detected through a feedback microphone. In step S302, one of a first configuration and a second configuration of the sound parameters is selected according to the sound signal to obtain a selected configuration. In step S303, audio is output through a speaker according to the selected configuration.

In summary, the electronic device of the disclosure may detect the sound of the surrounding environment through a feedback microphone and determine according to the detection result whether to switch to the in-ear earphone mode or the open earphone mode. The electronic device may configure sound parameters based on the earphone mode, so that the audio output by the electronic device matches the current earphone mode. To conserve energy, the electronic device may determine whether it is being worn according to the detection result of the skin sensor. If the electronic device is not being worn by the user, the electronic device may disable the feedback microphone to reduce power consumption.

What is claimed is:

1. An electronic device for an audio processing, comprising:
a feedback microphone, used to detect a sound signal;
a speaker; and
a processor, coupled to the feedback microphone and the speaker, wherein
the processor selects one of a first configuration and a second configuration of a sound parameter according to the sound signal to obtain a selected configuration, wherein
the processor outputs an audio through the speaker according to the selected configuration.

2. The electronic device according to claim 1, further comprising:
a skin sensor, coupled to the processor and generating a detection result, wherein
the processor activates the feedback microphone according to the detection result to detect the sound signal.

3. The electronic device according to claim 1, wherein
the processor obtains a feature value corresponding to the sound signal, and determines whether the feature value is greater than a threshold value, wherein
in response to the feature value being greater than the threshold value, the processor selects the first configuration as the selected configuration.

4. The electronic device according to claim 3, wherein
in response to the feature value being less than or equal to the threshold value, the processor selects the second configuration as the selected configuration.

5. The electronic device according to claim 3, wherein the feature value comprises a root mean square volume.

6. The electronic device according to claim 3, further comprising:
a filter, coupled to the processor, wherein the processor processes the sound signal using the filter to generate a filtered signal, and obtains a feature value of the filtered signal.

7. The electronic device according to claim 3, further comprising:
an environmental microphone, coupled to the processor and detecting an environmental sound signal, wherein
the processor determines the threshold value according to the environmental sound signal.

8. The electronic device according to claim 3, further comprising:
a transceiver, coupled to the processor, wherein
the processor is communicatively connected to an external electronic device through the transceiver and receives a calibration command from the external electronic device, wherein
in response to the calibration command, the processor detects a first sound signal and a second sound signal different from the first sound signal through the feedback microphone, wherein
the processor determines the threshold value according to the first sound signal and the second sound signal.

9. The electronic device according to claim 1, wherein the sound parameter comprises at least one of an equalizer parameter, an active noise cancellation parameter, and a compensation parameter.

10. The electronic device according to claim 1, wherein the electronic device comprises an earphone.

11. A method for an audio processing, comprising:
detecting a sound signal through a feedback microphone;
selecting one of a first configuration and a second configuration of a sound parameter according to the sound signal to obtain a selected configuration; and
outputting an audio through a speaker according to the selected configuration.

12. The method according to claim 11, further comprising:
generating a detection result through a skin sensor; and
activating the feedback microphone according to the detection result to detect the sound signal.

13. The method according to claim 11, wherein selecting the one of the first configuration and the second configuration of the sound parameter according to the sound signal to obtain the selected configuration comprises:
obtaining a feature value corresponding to the sound signal and determining whether the feature value is greater than a threshold value; and
in response to the feature value being greater than the threshold value, selecting the first configuration as the selected configuration.

14. The method according to claim 13, wherein selecting the one of the first configuration and the second configuration of the sound parameter according to the sound signal to obtain the selected configuration further comprises:
in response to the feature value being less than or equal to the threshold value, selecting the second configuration as the selected configuration.

15. The method according to claim 13, wherein the feature value comprises a root mean square volume.

16. The method according to claim 13, wherein obtaining the feature value corresponding to the sound signal comprises:
processing the sound signal using a filter to generate a filtered signal, and obtaining a feature value of the filtered signal.

17. The method according to claim 13, further comprising:
detecting an environmental sound signal through an environmental microphone; and
determining the threshold value according to the environmental sound signal.

18. The method according to claim 13, further comprising:
receiving a calibration command from an external electronic device;
in response to the calibration command, detecting a first sound signal and a second sound signal different from the first sound signal through the feedback microphone; and
determining the threshold value according to the first sound signal and the second sound signal.

19. The method according to claim 11, wherein the sound parameter comprises at least one of an equalizer parameter, an active noise cancellation parameter, and a compensation parameter.
